(19) United States
(12) Patent Application Publication
(10) Pub. No.: US 2004/0098704 A1
(43) Pub. Date: May 20, 2004

(54) Systems and methods for defining Web applications pages

(75) Inventors: Craig Henry Becker, Austin, TX (US); Stewart Earle Nickolas, Austin, TX (US); Wayne Elmo Vicknair, Austin, TX (US)

Correspondence Address: Barry S. Newberger, 5400 Renaissance Tower, 1201 Elm Street, Dallas, TX, 75270, US

(73) Assignee: International Business Machines Corporation, Armonk, NY

(21) Appl. No.: 10/294,941

(22) Filed: Nov. 14, 2002

(51) Int. Cl. G06F 9/44; G06F 9/46; G06F 15/00; G09G 5/00

(52) U.S. Cl. 717/115; 719/310; 715/513; 345/760

(57) ABSTRACT

A method, computer program product and system for building Web applications. A web application may be built by receiving a template where the template may comprise script and embedded source code for specifying at least one interface of the Web application and at least one operation of the Web application. A source code file in a high-level programming language may be generated where the source code file may include programming for specifying at least one interface and at least one operation of the Web application. The source code file maybe compiled to generate executable code corresponding to the Web application where the executable code includes a template portion for generating at least one interface and a portion for performing at least one operation of the Web application.

### CROSS-REFERENCE TO RELATED APPLICATIONS

Ser. No.______ (AUS9-2002-0327-US1), entitled “SYSTEMS AND METHODS FOR TRANSPARENTLY ACCESSING WEB APPLICATIONS REMOTELY AND LOCALLY”;

Ser. No.______ (AUS9-2002-0329-US1), entitled “SYSTEMS AND METHODS FOR MESSAGING IN A MULTI-FRAME WEB APPLICATION”;

Ser. No.______ (AUS9-2002-0330-US1), entitled “SYSTEMS AND METHODS FOR ACCESSING WEB SERVICES USING A TAG LIBRARY”; and

Ser. No.______ (AUS9-2002-0331-US1), entitled “SYSTEMS AND METHODS FOR DISPLAYING AND EXECUTING WEB SERVICES IN MULTIPLE DOMAINS”.

### TECHNICAL FIELD

The present invention is related in general to data processing systems, and in particular, to defining Web applications pages in a distributed data processing system.

### BACKGROUND INFORMATION

The advent of networked data processing systems, and, particularly, the network of networks referred to as the Internet, has spurred the introduction of distributed data processing services. In such systems, a client, typically remotely connected to the service provider via one or more networks, accesses a software application implemented on the remote data processing system which returns the results of the data processing activity to the client. It has become common to use the services represented by the World Wide Web (WWW) with its graphical user interface (GUI) orientation to provide the interface to such applications, which may be referred to a Web applications.

Typically, in such distributed processing systems, the client sends a request to the server. The request may include one or more parameters which may be inputs to the particular service requested. On the server side, the system builds a Web page for returning the response to the requesting client. The server accesses a server page containing code that defines the Web page. Embedded in the code for generating the page, i.e. HTML script, is code that is executable by the server to generate the necessary HTML script to display the results on the client machine.

A Web browser running on the client machine is an application that can interpret the HTML and display the page on a conventional display such as a CRT monitor connected to the client machine. Commercially available Web browsers include Netscape Navigator®, Mozilla, Internet Explorer®, iCab, and Opera. Technologies for implementing distributed computing services in this way include Active Server Pages (ASP) and Java™ Server Pages (JSP). Additionally, such services may access server-side application software to perform some or all of the requested tasks via an interprocess communication application program interface (API) such as DCOM (Distributed Component Object Model), CORBA (Common Object Request Broker Architecture) or Remote Method Invocation (RMI). In response to execution of the page by the server, the application software generates dynamic data and returns the data to the client which then displays the data in accordance with the code defining the page.

An example of such an application might be a Web application that handles employee travel reporting. Such a Web application may include multiple interfaces constituting multiple frames or windows, for the display of output from the Web application, as well as entry of input data. These HTML scripts defining such multiframe/multiwindow Web applications may be complex. (It would be recognized by those of ordinary skill in the art that, for the purposes herein, there is no material distinction between a multiwindow document and a multiframe document. The term “multiframe” may used to refer to both a multiframe document and a multiwindow document, generally.)

Thus, the development of multiframe/multiwindow Web applications may present a challenge for the Web application developer. The challenge maybe exacerbated by the need to deploy a Web application across multiple platforms. For example, as discussed in the commonly-owned copending U.S. Patent Application entitled “Systems And Methods For Transparently Accessing Web Applications Remotely and Locally” hereby incorporated herein by reference, a Web application may be deployed on a remote server and a client. Thus, there is a need in the art for systems and methods for developing Web applications, particularly systems and methods for facilitating development of platform neutral multiframe/multiwindow Web applications.

### SUMMARY OF THE INVENTION

The problems outlined above may at least in part be solved in some embodiments by deploying multiframe/multiwindow Web applications across multiple platforms. In one embodiment of the present invention, a method for building Web applications may comprise the step of receiving a template where the template may comprise script and embedded source code for specifying at least one interface of the Web application and at least one operation of the Web application. During the design of the Web application, the method may further comprise the step of generating a source code file in a high-level programming language that may contain programming statements for specifying at least one interface and at least one operation of the Web application. The method may further comprise the step of compiling the source code file to generate executable code corresponding to the Web application. The executable code generated includes a template portion for creating at least one interface and a portion for performing at least one operation of the Web application.

The foregoing has outlined rather broadly the features and technical advantages of one or more embodiments of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a network architecture for serving Web application pages which may be used in conjunction with the present invention;

FIG. 2 illustrates, in block diagram form, an architecture for building Web applications in accordance with the present inventive principles;

FIG. 3 illustrates, in block diagram form, an architecture for rendering Web application pages in accordance with the present inventive principles;

FIG. 4 illustrates, in flow chart form, a methodology for building Web application pages which maybe used in conjunction with the architecture of FIG. 2;

FIG. 5 illustrates, illustrates in flow chart form a methodology for rendering Web application pages which may be used in conjunction with the architecture of FIG. 3;

FIG. 6 illustrates, in block diagram form, a data processing system for generating document components for accessing Web applications in accordance with an embodiment of the present invention; and

FIG. 7 illustrates, in block diagram form, a data processing system for performing Web application requests in accordance with an embodiment of the present invention.

### DETAILED DESCRIPTION

In the following description, numerous specific details are set forth to provide a thorough understanding of the present invention. For example, exemplary code for accessing particular Web applications may be described, however it would be recognized by those of ordinary skill in the art that the present invention may be practiced without such specific details, and in other instances, well-known circuits have been shown in block diagram form in order not to obscure the present invention in unnecessary detail. Refer now to the drawings wherein depicted elements are not necessarily shown to scale and wherein like or similar elements are designated by the same reference numeral through the several views.

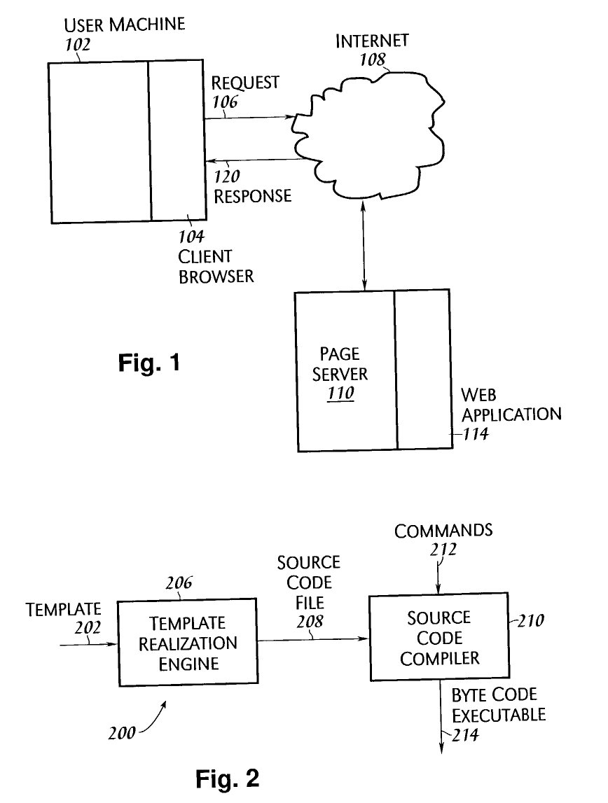

Referring to FIG. 1, there is illustrated a distributed data processing system architecture 100 which may be used for accessing Web applications in accordance with the present inventive principles. A Web application may be accessed when a request for a web document, or page, is received from a user machine, such as user machine 102, running a client web browser 104. Client browser 104 initiates a request 106, which is transmitted to the targeted web server, illustrated by page server 110, in FIG. 1, via a network, shown in FIG. 1 as Internet 108.

Page server 110 responds to the request by returning the requested page in response 120. The requested page may include data that is to be generated dynamically. Dynamic data may be generated by web application 114 and the result incorporated in the page returned in response 120 to client browser 104, which displays the data in accordance with the code defining the page, which may be, for example, an HTML (Hypertext Markup Language) script.

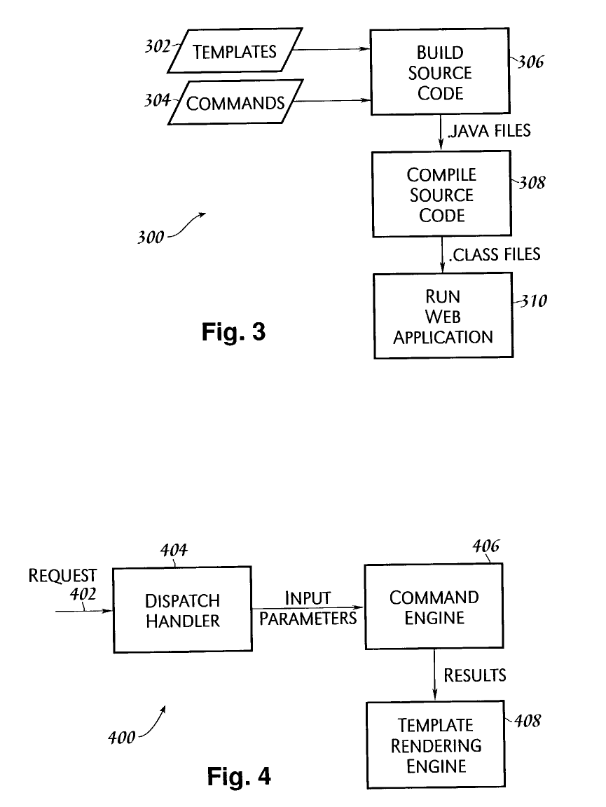

Additionally, as described further in conjunction with FIG. 3, a Web application may be deployed locally (not shown in FIG. 1). A mechanism for transparently accessing such a client-resident web application is described in the commonly-owned, copending U.S. Patent Application entitled “Systems And Methods for Transparently Accessing Web Applications Remotely and Locally,” Ser. No. 10/______, which has been incorporated herein by reference.

Refer now to FIG. 2 illustrating architecture 200 which may be used to build Web applications in accordance with the present invention. Template 202 may be input to a template realization engine 206. Template 202 provides a framework for the layout of the Web application pages to be built. A template includes scripts, typically HTML scripts, and embedded high-level programming language source code, typically Java™ source code, for specifying the Web application pages. The high-level programming language source code included in a template will be, for simplicity of notation, referred to as embedded source code.

In response to the template, template realization engine 206 outputs a source code file 208, which may be in a high-level programming language, such as Java™. That is, template realization engine 206 transforms the scripts and embedded source code to generate source code 208. Source code 208 may implement the functionality of the Web application being developed, as well as the user interface of the Web application; that is, the Web pages of the application. In other words, source code 208, when compiled into an executable program, operates to provide the functionality of the Web application, and generate the Web application pages that are returned to the client in response to a Web application request. This will be described further in conjunction with FIGS. 3-5.

Source code 208 is provided as input to source code compiler 210, which generates the executable program. Additionally, an interface to the operations of the Web application may be provided by a set of commands, which may further be provided as a source code input 212 to source code compiler 210. This interface may be encapsulated in a command object, having methods for setting parameters, executing operations and retrieving results. Such a command model structure may be:

aCommand.setX(param_X);

aCommand.setY(param_Y);

aCommand.execute( );

result=aCommand.getResult( );

Compiler 210 outputs executable code 214, which may be a platform independent code, such as Java™ class files. It would be recognized by those of ordinary skill in the art that Java™ class files maybe bytecode that represents executable code for the Java™ Virtual Machine (JVM). For notational convenience, platform independent executable code may be referred to generically as bytecode.

The flow charts provided herein are not necessarily indicative of the serialization of operations being performed in an embodiment of the present invention. Steps disclosed within these flow charts may be performed in parallel. The flow charts are indicative of those considerations that may be performed to produce the operations available for building Web applications. It is further noted that the order presented is illustrative and does not necessarily imply that the steps must be performed in order shown.

The operation of architecture 200 is illustrated in FIG. 3, depicting, in flow chart form a process 300 for building a Web application. In steps 302, and 304 templates including page scripts and embedded source code, and code embodying a command interface are respectively input. In step 306, source code files in the high-level programming language are built. In an embodiment in which the high-level language is Java™, the output files may constitute Java™ source code (i.e. .java files). The source code implements the functionality of the Web application, the methods to handle input received in a request from the user, as further described hereinbelow, as well as generating the Web pages that embody the GUI of the Web application.

In step 308, the source code is compiled into executable code. If the source code is in Java™, it would be recognized by those of ordinary skill in the art that the executable code may be bytecode that represents executable code for the Java™ Virtual Machine (JVM). In step 310, the executable code files , for example Java™ .class files, are executed. That is, the Web application is run. Typically, these are executed on the page server, such as page server 110, FIG. 1, hosting the Web application. However, as described in the commonly-owned, copending U.S. Patent Application entitled “Systems and Methods For Transparently Accessing Web Applications Remotely and Locally,” Ser. No. 10/______, which is hereby incorporated herein by reference, the executable code may also be deployed on the client, and the Web application accessed locally.

Referring now to FIG. 4, there is illustrated therein an architecture 400 for accessing a Web application in accordance with the present inventive principles. A request 402 to access the Web application may be input to dispatch handler 404. Request 402 may, for example, include a URI (Uniform Resource Identifier) of the Web application received from a client browser, such as browser 104, FIG. 14. Dispatch handler 404 dispatches the request to the target specified by the URI. Dispatch handler 404 may be a Javascript API, as described in the aforementioned U.S. Patent Application entitled “Systems and Methods For Transparently Accessing Web Applications Remotely and Locally.” As discussed therein, associated with the request may be user supplied data that represents input information to the Web application. Dispatch handler 404 may parameterize the user-supplied data, and pass the data to command engine 406. In an embodiment of the present invention, command engine 406 may be a Java™ servlet. Command engine 406 may determine the command function to execute. Commands may set input values, execute the web application, and return results, typically by rendering a template as a response to the client, via template rendering engine 408. Note that command engine 406 and template rendering engine 408 may be implemented in the executable code generated as described above in conjunction with FIGS. 2 and 3.

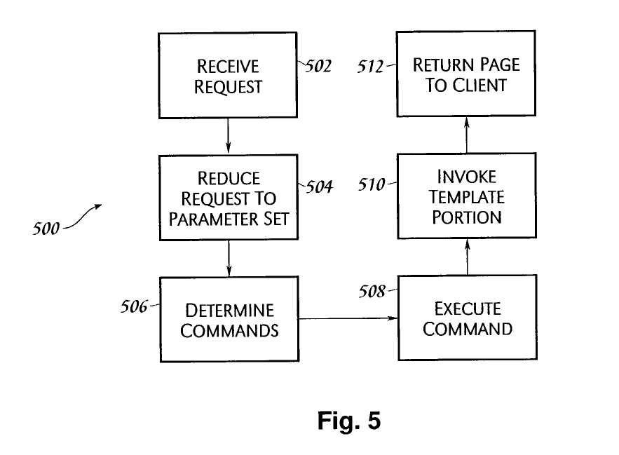

FIG. 5 illustrates, in flow chart form, methodology 500 for accessing a Web application in accordance with the principles of the present invention. Methodology 500 may be performed in conjunction with architecture 400, FIG. 4.

In step 502, a request for the Web application is received. The request may be reduced to a set of parameterized data representing input data to the Web application, step 504. In step 506, the commands to execute are determined. Step 506 may be performed in conjunction with the command model, previously discussed. In step 508, the command method is executed, and in response the command invokes a template portion of the executable code, step 510. The template portion generates a page constituting the response to the request to the Web application. That is, the template portion outputs the HTML (or other script) defining the page that represents the response of the Web application to the request received in step 502. In step 512, the page is returned to the client. The response may then be displayed in the target frame/window on the client.

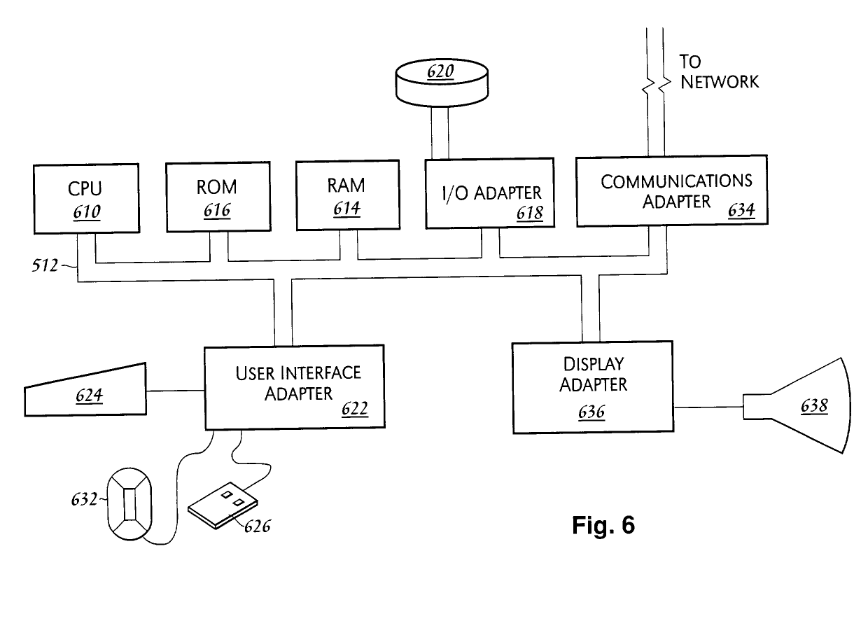

A representative hardware environment for practicing the present invention is depicted in FIG. 6, which illustrates an exemplary hardware configuration of data processing system 600 in accordance with the subject invention. For example, client 104, FIG. 1 may be implemented in accordance with data processing system 600. System 600 includes central processing unit (CPU) 610, such as a conventional microprocessor, and a number of other units interconnected via system bus 612. Data processing system 600 includes random access memory (RAM) 614, read only memory (ROM) 616, and input/output (I/O) adapter 618 for connecting peripheral devices such as disk units 620 to bus 612, user interface adapter 622 for connecting keyboard 624, mouse 626, and/or other user interface devices such as a touch screen device (not shown) to bus 612. System 600 also includes communication adapter 634 for connecting data processing system 600 to a data processing network enabling the data processing system to communicate with other systems, and display adapter 636 for connecting bus 612 to display device 638. CPU 610 may include other circuitry not shown herein, which will include circuitry commonly found within a microprocessor, e.g., execution unit, bus interface unit, arithmetic logic unit, etc. CPU 610 may also reside on a single integrated circuit.

Display monitor 638 is connected to system bus 612 by display adapter 636. In this manner, a user is capable of inputting to the system throughout the keyboard 654, trackball 635 or mouse 656 and receiving output from the system via speaker 658, display 638.

Preferred implementations of the invention include implementations as a computer system programmed to execute the method or methods described herein, and as a computer program product. According to the computer system implementation, sets of instructions for executing the method or methods are resident in the random access memory 614 of one or more computer systems configured generally as described above. These sets of instructions, in conjunction with system components that execute them may execute a Web application. Until required by the computer system, the set of instructions maybe stored as a computer program product in another computer memory, for example, in disk drive 620 (which may include a removable memory such as an optical disk or floppy disk for eventual use in the disk drive 620). Further, the computer program product can also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical, biological, or some other physical change. While it is convenient to describe the invention in terms of instructions, symbols, characters, or the like, the reader should remember that all of these and similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

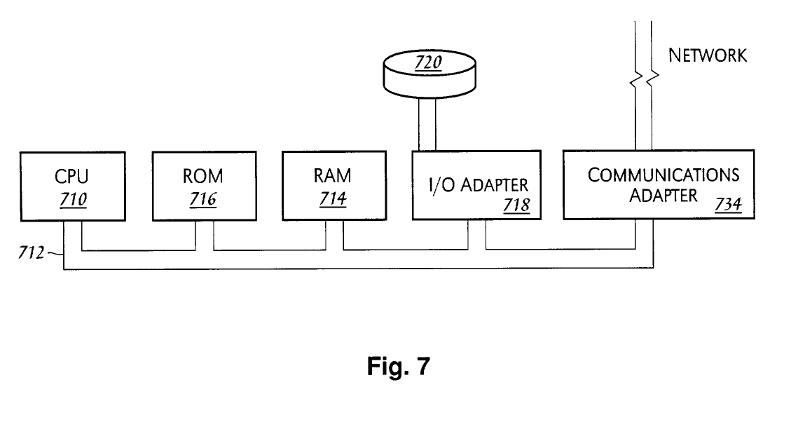

FIG. 7 illustrates an exemplary hardware configuration of data processing system 700 in accordance with the subject invention. For example, Web application server 114, FIG. 1, may be implemented in accordance with data processing system 700. System 700 includes central processing unit (CPU) 710, such as a conventional microprocessor, and a number of other units interconnected via system bus 712. Data processing system 700 includes random access memory (RAM) 714, read only memory (ROM) 716, and input/output (I/O) adapter 718 for connecting peripheral devices such as disk units 720 to bus 712. System 700 also includes communication adapter 734 for connecting data processing system 700 to a data processing network enabling the data processing system to communicate with other systems. CPU 710 may include other circuitry not shown herein, which will include circuitry commonly found within a microprocessor, e.g., execution unit, bus interface unit, arithmetic logic unit, etc. CPU 710 may also reside on a single integrated circuit.

Preferred implementations of the invention include implementations as a computer system programmed to execute the method or methods described herein, and as a computer program product. According to the computer system implementation, sets of instructions for executing the method or methods are resident in the random access memory 714 of one or more computer systems configured generally as described above. These sets of instructions in conjunction with the system components which execute them, may execute a Web application. In particular, system 700 may execute the platform independent class files generated in accordance with the methodology described in conjunction with FIGS. 3-5. Until required by the computer system, the set of instructions may be stored as a computer program product in another computer memory, for example, in disk drive 720 (which may include a removable memory such as an optical disk or floppy disk for eventual use in the disk drive 720). Further, the computer program product can also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical, biological, or some other physical change. While it is convenient to describe the invention in terms of instructions, symbols, characters, or the like, the reader should remember that all of these and similar terms should be associated with the appropriate physical elements.

Although the present invention and its advantages have been described in detail, it should be understood that various changes, substitutions and alterations can be made herein without departing from the spirit and scope of the invention as defined by the appended claims.

What is claimed

1. A method for building Web applications comprising:
receiving a template, the template comprising script and embedded source code for specifying at least one interface of the Web application and at least one operation of the Web application;
generating a source code file in a high-level programming language, wherein the source code file comprises programming for specifying at least one interface and at least one operation of the Web application; and
compiling the source code file to generate executable code corresponding to the Web application, the executable code including a template portion for generating at least one interface and a portion for performing at least one operation of the Web application.

2. The method of claim 1 wherein the executable code comprises code in a platform neutral format, the code being executable by a virtual machine.

3. The method of claim 1 further comprising receiving high-level program instructions for implementing a command object, wherein the step of compiling includes compiling the high-level programming instructions for implementing the command object.

4. The method of claim 1 further comprising:
determining a command corresponding to an operation of the Web application in response to a data parameter obtained from a request accessing the Web application;
invoking the template portion in response to the command from the determining step; and
outputting, in response to the step of invoking the template portion, a page comprising a response to the request.

5. The method of claim 4 wherein the data parameter is obtained from the request by a dispatch handler in a top level document of the Web application.

6. The method of claim 5 wherein the dispatch handler is operable for reducing the request to a parameter set, the data parameter comprising a member of the parameter set.

7. A computer program product embodied in a machine-readable storage medium comprising programming instructions for performing the steps of:
receiving a template, the template comprising script and embedded source code for specifying at least one interface of the Web application and at least one operation of the Web application;
generating a source code file in a high-level programming language, wherein the source code file comprises programming for specifying at least one interface and at least one operation of the Web application; and
compiling the source code file to generate executable code corresponding to the Web application, the executable code including a template portion for generating at least one interface and a second portion for performing at least one operation of the Web application.

8. The program product of claim 7 wherein the executable code comprises code in a platform neutral format, the code being executable by a virtual machine.

9. The program product of claim 7 further comprising programming instructions for performing the step of receiving high-level program instructions for implementing a command object, wherein the step of compiling includes compiling the high-level programming instructions for implementing the command object.

10. The program product of claim 7 further comprising programming instructions for performing the steps of:
determining a command corresponding to an operation of the Web application in response to a data parameter obtained from a request accessing the Web application;
invoking the template portion in response to the command from the determining step; and
outputting, in response to the step of invoking the template portion, a page comprising a response to the request.

11. The program product of claim 10 wherein the data parameter is obtained from the request by a dispatch handler in a top level document of the Web application.

12. The program product of claim 11 wherein the dispatch handler is operable for reducing the request to a parameter set, the data parameter comprising a member of the parameter set.

13. A data processing system for building Web applications comprising:
circuitry operable for receiving a template, the template comprising script and embedded source code for specifying at least one interface of the Web application and at least one operation of the Web application;
circuitry operable for generating a source code file in a high-level programming language, wherein the source code file comprises programming for specifying at least one interface and at least one operation of the Web application; and
circuitry operable for compiling the source code file to generate executable code corresponding to the Web application, the executable code including a template portion for generating at least one interface and a second portion for performing at least one operation of the Web application.

14. The system of claim 13 wherein the executable code comprises code in a platform neutral format, the code being executable by a virtual machine.

15. The system of claim 13 further comprising circuitry operable for receiving high-level programming instructions for implementing a command object, wherein the step of compiling includes compiling the high-level programming instructions for implementing the command object.

16. The system of claim 13 further comprising:
circuitry operable for determining a command corresponding to an operation of the Web application in response to a data parameter obtained from a request accessing the Web application;
circuitry operable for invoking the template portion in response to the command from the determining step; and
circuitry operable for outputting, in response to the step of invoking the template portion, a page comprising a response to the request.

17. The system of claim 16 wherein the data parameter is obtained from the request by a dispatch handler in a top level document of the Web application.

18. The system of claim 5 wherein the dispatch handler is operable for reducing the request to a parameter set, the data parameter comprising a member of the parameter set.

19. A method for building Web applications comprising:
receiving a template, the template comprising script and embedded source code for specifying at least one interface of the Web application and at least one operation of the Web application;
generating a source code file in a high-level programming language, wherein the source code file comprises programming for specifying at least one interface and at least one operation of the Web application;
compiling the source code file to generate executable code corresponding to the Web application, the executable code including a template portion for generating at least one interface and a portion for performing at least one operation of the Web application;
determining a command corresponding to an operation of the Web application in response to a data parameter obtained from a request accessing the Web application;
invoking the template portion in response to the command from the determining step; and
outputting, in response to the step of invoking the template portion, a page comprising a response to the request.
